(19) United States
(12) Patent Application Publication
(10) Pub. No.: US 2024/0213876 A1
(43) Pub. Date: Jun. 27, 2024

(54) POWER CONVERSION APPARATUS

(71) Applicants: KABUSHIKI KAISHA TOSHIBA, Tikyo (JP); TOSHIBA INFRASTRUCTURE SYSTEMS & SOLUTIONS CORPORATION, Kawasaki-shi (JP)

(72) Inventors: Yuta HAMAKAWA, Fuchu Tokyo (JP); Takeshi MATSUO, Tama Tokyo (JP); Yuichiro NOZAKI, Mitaka Tokyo (JP); Tsunehito FUJITA, Musashino Tokyo (JP)

(73) Assignees: KABUSHIKI KAISHA TOSHIBA, Tokyo (JP); TOSHIBA INFRASTRUCTURE SYSTEMS & SOLUTIONS CORPORATION, Kawasaki-shi (JP)

(21) Appl. No.: 18/392,221

(22) Filed: Dec. 21, 2023

(30) Foreign Application Priority Data
Dec. 26, 2022 (JP) 2022-207831

(51) Int. Cl. H02M 3/00; G01K 3/00; G01K 7/22; G01K 19/00; H02M 1/00; H02M 1/32; H02M 3/335

(52) U.S. Cl. CPC H02M 3/015; G01K 3/005; G01K 7/22; G01K 19/00; H02M 1/0058; H02M 1/327; H02M 3/33571

(57) ABSTRACT

According to one embodiment, an apparatus is prevented from being stopped by a breakdown of one or more of multiple temperature detector used to detect an abnormality of a resonance frequency. The apparatus includes: a circuit that adjusts power from a power supply to power of a desired voltage; an inverter that converts the power output by the circuit into alternate-current power; a resonance circuit having an inductance and a capacitance; a transformer that converts the alternate-current power; a rectifier that converts the alternate-current into direct-current power; temperature detector that detects temperatures of the resonance circuit; and a controller that detects an abnormality of a resonance frequency in response to that the temperatures are equal to or higher than a predetermined temperature threshold, and, in response to that the temperature detector of the resonance circuit is abnormal, executes control for handling the abnormality of the temperature detector.

### CROSS-REFERENCE TO RELATED APPLICATION (S)

This application is based upon and claims the benefit of priority from Japanese Patent Application No. 2022-207831, filed Dec. 26, 2022; the entire contents of which are incorporated herein by reference.

### FIELD

Embodiments described herein relate generally to a power conversion apparatus having a DC/DC converter that converts input direct-current power into electrically-insulated direct-current power.

### BACKGROUND

While reduction in size and weight of a power conversion apparatus has conventionally been implemented, further reduction in size and weight of a power conversion apparatus is demanded.

As one way of achieving this, it has been suggested that a DC/DC converter having a soft-switching function that uses a resonance circuit as part of the circuitry be adopted to provide higher frequency, thereby reducing the outer volume and the mass of a reactor and a transformer in the apparatus, and also reducing the size and the weight of the power conversion apparatus.

In general, soft switching using a resonance circuit (i.e., turning on and off a switching element when current is small) is performed in this circuitry mode; thus, the circuitry is configured so as to be able to suppress switching element loss to low levels even though high-frequency switching is performed.

However, in response to that such a circuitry configuration is adopted, a turn-off during the passing of the current through the switching element (i.e., hard switching) occurs when the resonance frequency of the resonance circuit part decreases for some reason, likely resulting in an increased loss. Also, in response to that the resonance frequency increases, resistance loss of each component may increase due to an increase in a current amplitude.

To solve such a problem, a method has been suggested that entails providing a current detector in a resonance circuit to detect a resonant current, monitoring a resonance frequency, detecting an abnormality of the resonance frequency when the resonance frequency is outside a predetermined range, and then stopping the apparatus.

### BRIEF DESCRIPTION OF THE DRAWINGS

FIG. 1 is diagram showing a configuration of a power conversion apparatus according to a first embodiment.

FIG. 2 is a diagram explaining a relationship between a gate voltage of a switching element and a current of each component when a resonance frequency is normal.

FIG. 3 is a diagram explaining a relationship between a gate voltage of a switching element and a current of each component when a resonance frequency is abnormal.

FIG. 4 is a process flowchart for a first process of detecting an abnormality of a resonance frequency.

FIG. 5 is a process flowchart for a second process of detecting an abnormality of a resonance frequency.

FIG. 6 is a process flowchart for a third process of detecting an abnormality of a resonance frequency.

FIG. 7 is a process flowchart for a process of detecting an abnormality of a thermistor according to the first embodiment.

FIG. 8 is a process flowchart for a process of detecting an abnormality of a thermistor according to a second embodiment.

FIG. 9 is a process flowchart for a process of detecting an abnormality of a thermistor according to a third embodiment.

FIG. 10 is a process flowchart for a process of detecting an abnormality of a thermistor according to a fourth embodiment.

FIG. 11 is a process flowchart for a process of detecting an abnormality of a thermistor according to a fifth embodiment.

### DETAILED DESCRIPTION

A power conversion apparatus according to an embodiment includes a voltage adjusting circuit configured to adjust power from a power supply to power of a desired voltage; an inverter configured to convert the power output by the voltage adjusting circuit into alternate-current power; a resonance circuit having an inductance and a capacitance; a high-frequency transformer configured to convert a voltage of the alternate-current power of the inverter; a rectifier configured to convert the alternate-current power output from the high-frequency transformer into direct-current power; temperature detector configured to detect respective temperatures of two or more areas of the resonance circuit; and a controller configured to: detect an abnormality of a resonance frequency in response to that the temperatures are equal to or higher than a predetermined temperature threshold, and execute control for handling the abnormality; and also detect an abnormality of the temperature detector configured to detect the temperatures of the resonance circuit, and, in response to that the controller detects an abnormality of the temperature detector, execute control to cut off an abnormal output from the temperature detector from the detection of an abnormality of the resonance frequency.

Hereinafter, embodiments will be described with reference to the drawings.

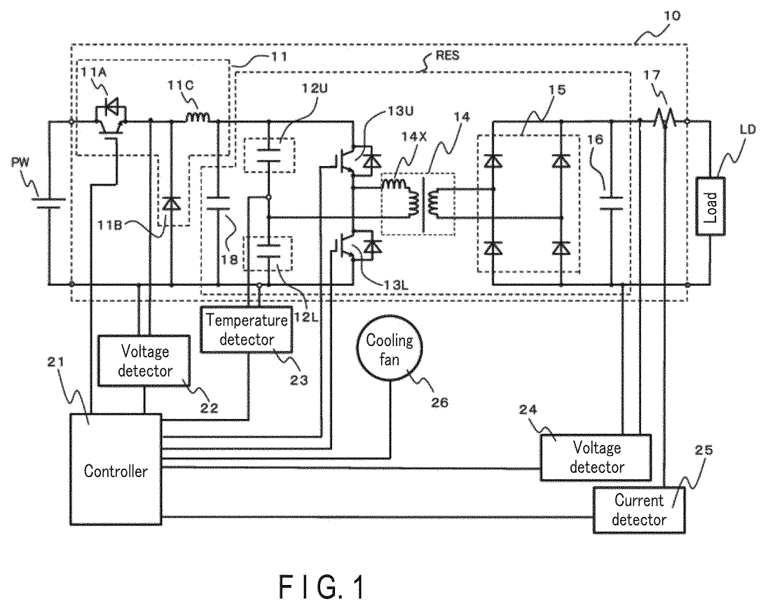

FIG. 1 is diagram showing a configuration of a power conversion apparatus according to a first embodiment.

A power conversion apparatus includes: a direct-current power supply PW; a voltage adjusting circuit 11; resonance capacitors (capacitance) 12U and 12L, a switching element 13U (upper arm: switching transistor), and a switching element 13L (lower arm; switching transistor) that constitute a resonant inverter as a resonant single-phase half-bridge inverter; a high-frequency transformer 14; a rectifier 15; a filter capacitor 16; a current detector 17; a filter capacitor 18; a controller 21; a voltage detector 22 that detects a voltage input by the voltage adjusting circuit 11; a temperature detector 23 that detects a temperature representative of temperatures of the resonance capacitor 12U and the resonance capacitor 12L; a voltage detector 24 that detects a voltage output by the power conversion apparatus; a current detector 25 that detects a current output by the power conversion apparatus based on a signal output by the current detector 17; and a cooling fan 26 that cools the resonance capacitors 12U and 12L and a peripheral circuit.

In the above structure, the resonance capacitors 12U and 12L, the switching element 13U, the switching element 13L, the high-frequency transformer 14, the rectifier 15, the filter capacitor 16, and the filter capacitor 18 constitute a resonance circuit RES.

The example shown in FIG. 1 illustrates the case where a step-down chopper circuit having a switching element 11A, a diode 11B, and a coil 11C is formed as the voltage adjusting circuit 11. However, in response to that an adjustment can be made so as to obtain a desired voltage, various circuits such as a step-up/step-down chopper circuit, a step-up chopper circuit, and a converter can be applied as the voltage adjusting circuit 11.

The high-frequency transformer 14 is, for example, a transformer circuit and includes a leakage inductance component 14X.

The controller 21 is connected to the voltage detector 22, the temperature detector 23, the voltage detector 24, and the current detector 25. While the output is being detected by the voltage detector 24 and the current detector 25, gate control of the switching element 11A is performed based on given control characteristics.

In FIG. 1, the switching element 11A, the switching element 13U, and the switching element 13L are IGBTs; however, they need not necessarily be IGBTs. For example, the switching element 11A, the switching element 13U, and the switching element 13L may be SiC-MOSFETs, power transistors, or GTO thyristors.

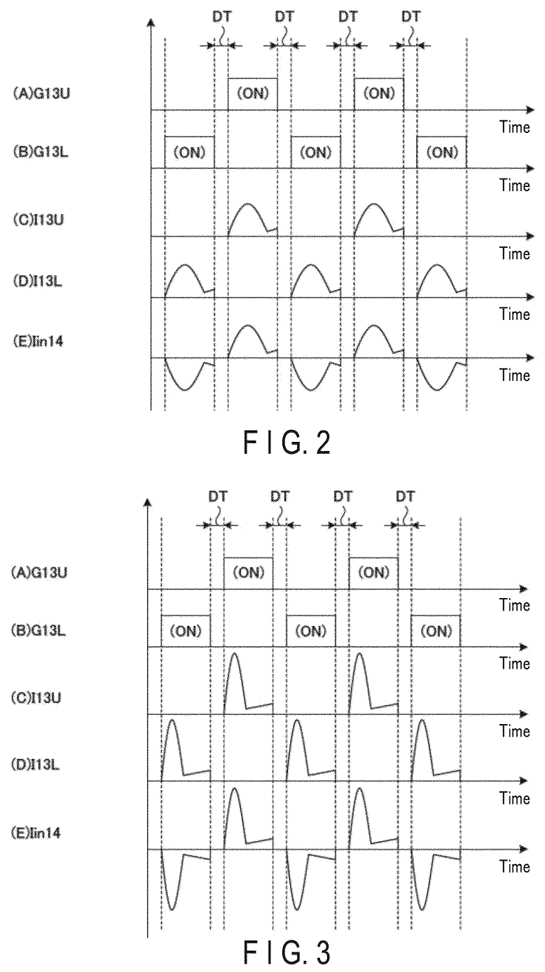

FIG. 2 is a diagram explaining a relationship between a gate voltage of a switching element and a current of each component when a resonance frequency is normal.

As shown in FIG. 2(A) and FIG. 2(B), a gate voltage G13U of the switching element 13U and a gate voltage G13L of the switching element 13L are exclusively switched between an “H” level (“ON”) and an “L” level (“OFF”) through a predetermined dead time DT.

In response to that the switching element 13U is on, a current I13U passes through the switching element 13U, as shown in FIG. 2(C). Likewise, in response to that the switching element 13L is on, a current I13L passes through the switching element 13L, as shown in FIG. 2(D).

Consequently, a current Iin14 passes through a primary side of the high-frequency transformer 14, as shown in FIG. 2(E).

At a normal time, the controller 21 controls the switching elements 13U and 13L at a set switching cycle.

A total value of the leakage inductance 14X of the high-frequency transformer 14 and an inductance of wiring constituted by a conductor forming a closed circuit of the switching elements 13U and 13L, the high-frequency transformer 14, the diode rectifier 15, and the filter capacitors 16 and 18, and the resonance capacitors 12U and 12L constitute the resonance circuit RES and supply power to the load.

Thus, the switching frequency and the resonance frequency constitute the timing for implementing soft switching (i.e., turning off with a small current).

That is, in the first half of the switching cycle, a large amount of current I13U passes in the first half of the period in which the gate voltage G13U of the switching element 13U is in an “H” level, and the amount of current I13U is small in the period of the dead time DT set for switching the switching elements 13U and 13L, as shown in FIG. 2, so that soft switching can be performed.

Also, in the second half of the switching cycle, a large amount of current I13L passes in the first half of the period in which the gate voltage G13L of the switching element 13L is in an “H” level, and the amount of current I13L is small in the period of the dead time DT set for switching the switching elements 13U and 13L, so that soft switching can be performed.

FIG. 3 is a diagram explaining a relationship between a gate voltage of a switching element and a current of each component when a resonance frequency is abnormal due to a decrease in the capacity of the resonance capacitor or the like.

At an abnormal time also, in the first half of the switching cycle T, a large amount of current I13U passes in the first half of the period in which the gate voltage G13U of the switching element 13U is in an “H” level, and the amount of current I13U is small in the period of the dead time DT set for switching the switching elements 13U and 13L.

However, a value of the current passing in the first half of the period in which the gate voltage G13U of the switching element 13U is in an “H” level is larger, as compared to that at a normal time; thus, a large amount of heat is generated throughout the entire circuit.

Likewise, in the second half of the switching cycle, a large amount of current I13L passes in the first half of the period in which the gate voltage G13L of the switching element 13L is in an “H” level, and the amount of current I13L is small in the period of the dead time DT set for switching the switching elements 13U and 13L.

However, a value of the current passing in the first half of the period in which the gate voltage G13L of the switching element 13L is in an “H” level is larger, as compared to that at a normal time; thus, power consumption increases and a large amount of heat is generated throughout the entire circuit.

More specifically, when the inductance of the entire resonance circuit is represented as L, and the capacitance of the entire resonance circuit is represented as C, the resonance frequency f is expressed by the following equation (1):

$$f = 1 / 2 π \cdot √ ( L \cdot C ) \qquad ( 1 )$$

Thus, in response to that the capacitance C decreases, so does the resonance frequency, resulting in an inability of the entire circuit to perform a desired operation.

Accordingly, in this embodiment, control is performed by detecting a change in the temperature to thereby detect a change in the resonance frequency.

That is, the temperature detector 23 monitors the temperatures of the resonance capacitors 12U and 12L or the temperatures of the conductors connected to the resonance capacitors 12U and 12L. The temperature detector 23 may include a plurality of temperature detect means detecting the temperatures of a plurality of monitoring target areas and may output a plurality of temperature measurement values. The power conversion apparatus may include a plurality of temperature detectors 23 corresponding to a plurality of monitoring target areas and each of temperature detectors 23 may output a temperature measurement value of the corresponding monitoring target area.

In response to that at least one of the temperatures are outside a temperature range that should be detected by the temperature detector 23 at a normal time, the controller 21 detects the abnormality of the resonance frequency based on the output from the temperature detector 23 and causes the power conversion apparatus 10 to enter a stop mode.

The operation of the controller 21 will be explained in more detail below.

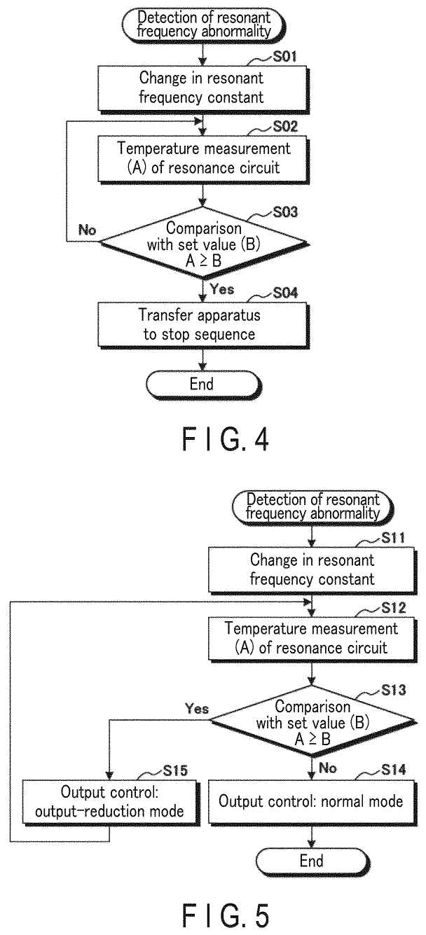

FIG. 4 is a process flowchart for a first process of detecting an abnormality of a resonance frequency.

While the resonance frequency is abnormal due to a change in the constant of the resonance frequency (step S01), the controller 21 measures, via the temperature detector 23, a temperature of the resonance circuit, that is, temperatures of the resonance capacitors 12U and 12L or the conductors connected to the resonance capacitors 12U and 12L, and acquires a temperature measurement value A (step S02).

Subsequently, the controller 21 compares a temperature set value B, which corresponds to a preset temperature threshold, with the temperature measurement value A, and determines whether or not the temperature measurement value A is equal to or greater than the temperature set value B (A≥B) (step S03).

If it is determined in step S03 that the temperature measurement value A is equal to or greater than the temperature set value B (A≥B) (step S03; Yes), the controller 21 causes the operation of the power conversion apparatus 10 to enter a stop sequence (step S04) to protect the power conversion apparatus 10.

If it is determined in step S03 that the temperature measurement value A is less than the temperature set value B (A<B) (step S03; No), the controller 21 returns to step S02 to repeat the same process.

FIG. 5 is a process flowchart of a second process of detecting an abnormality of a resonance frequency.

In the process shown in FIG. 4, the power conversion apparatus 10 is caused to enter a stop sequence if the resonance frequency is abnormal. In the process shown in FIG. 5, however, the power conversion apparatus 10 is protected by reducing the output power.

While the resonance frequency is abnormal due to a change in the constant of the resonance frequency (step S11), the controller 21 measures, via the temperature detector 23, a temperature of the resonance circuit, that is, temperatures of the resonance capacitors 12U and 12L or the conductors connected to the resonance capacitors 12U and 12L, and acquires a temperature measurement value A (step S12).

Subsequently, the controller 21 compares a temperature set value B, which corresponds to a preset temperature threshold, with the temperature measurement value A, and determines whether or not the temperature measurement value A is equal to or greater than the temperature set value B (A≥ B) (step S13).

If it is determined in step S13 that the temperature measurement value A is equal to or greater than the temperature set value B (A≥B) (step S13; Yes), the controller 21 controls the output from the power conversion apparatus 10 and causes the power conversion apparatus 10 to enter an output-reduction mode of reducing output (step S15) to protect the power conversion apparatus 10. Also, in order to determine whether or not further reduction of output is needed, the controller 21 returns to step S12 to repeat the same process.

On the other hand, if it is determined in step S13 that the temperature measurement value A is less than the temperature set value B (A<B) (step S13; No), the controller 21 ends the process with the output control maintained in a normal mode (step S14).

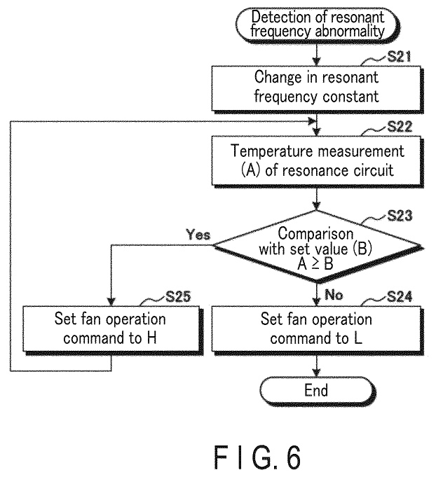

FIG. 6 is a process flowchart for a third process of detecting an abnormality of a resonance frequency.

This example explains an instance in which the power conversion apparatus includes a cooling fan 26 as a cooling device for cooling the resonance capacitors 12U and 12L forming the resonance circuit.

In the process shown in FIG. 4, the controller 21 causes the power conversion apparatus 10 to enter a stop sequence in response to that the resonance frequency is abnormal. In the process shown in FIG. 6, however, the power conversion apparatus 10 is protected by cooling the resonance capacitors 12U and 12L and a peripheral circuit.

While the resonance frequency is abnormal due to a change in the constant of the resonance frequency (step S21), the controller 21 measures, via the temperature detector 23, a temperature of the resonance circuit, that is, temperatures of the resonance capacitors 12U and 12L or the conductors connected to the resonance capacitors 12U and 12L, and acquires a temperature measurement value A (step S22).

Subsequently, the controller 21 compares a temperature set value B, which corresponds to a preset temperature threshold, with the temperature measurement value A, and determines whether or not the temperature measurement value A is equal to or greater than the temperature set value B (A≥B) (step S23).

If it is determined in step S23 that the temperature measurement value A is equal to or greater than the temperature set value B (A≥B) (step S23; Yes), the controller 21 causes the cooling fan to operate by setting a fan operation command for controlling the operation of the cooling fan to an “H” level (step S25), and cools the resonance capacitors 12U and 12L and a peripheral circuit to protect the power conversion apparatus 10.

On the other hand, if it is determined in step S23 that the temperature measurement value A is less than the temperature set value B (A<B) (step S23; No), the controller 21 stops the cooling fan by setting the fan operation command for controlling the operation of the cooling fan to an “L” level or ends the process with the stop state maintained (step S24).

As explained above, this embodiment makes it possible to easily detect an abnormality of a resonance frequency at a low cost and protect the power conversion apparatus 10.

In the embodiment disclosed herein, a thermistor is used as the temperature detector and attached to each of the terminals of the resonance capacitors 120 and 12L and/or to each of the conductors connected to the resonance capacitors 12U and 12L, thereby monitoring the temperatures with their individual temperature set values. Thus, if one of the four thermistors breaks down, the broken thermistor may erroneously detect an excess temperature and stop the apparatus even if the resonance frequency or the actual temperature of the temperature monitoring part (to which the thermistor is attached) is normal.

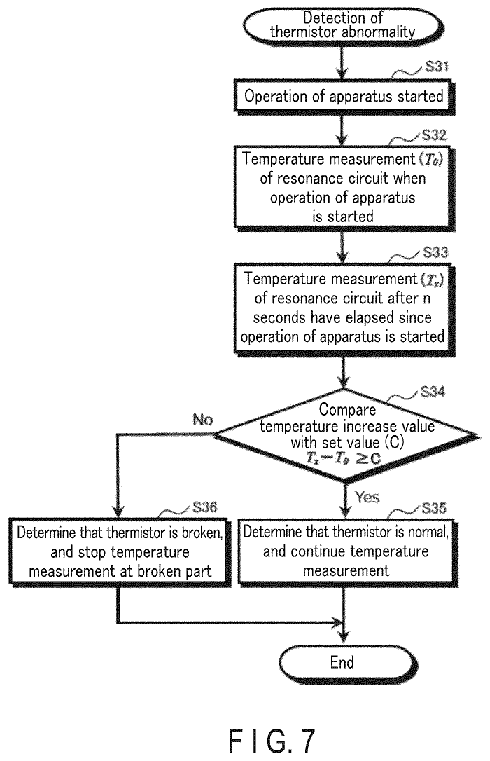

FIG. 7 is a process flowchart explaining a method of detecting an abnormality of a thermistor according to the first embodiment. When the operation of the power conversion apparatus 10 is started, the temperature detector 23 detects an initial temperature T0 measured by the thermistors attached to the resonance capacitors 12U and 12L and/or to the conductors connected to the resonance capacitors 12U and 12L, and stores the initial temperature TO in the controller 21 (step S32). When a sufficient time t1 elapses after the operation of the apparatus is started, a temperature Tx at that time point is measured (step S33). For example, if a sufficient time t1 is 100 seconds, the controller 21 counts 100 seconds once the operation of the apparatus is started, and stores a temperature Tx as of completion of the counting of 100 seconds.

The time when the operation of the power conversion apparatus 10 is started may include a period that includes both a time point at which the operation of the power conversion apparatus 10 is started (an operation starting time point) and a period from the operation starting time point to a time point at which a predetermined time (<time t1) has elapsed, or include a period that includes both the operation starting time point of the power conversion apparatus 10 and a period from the operation starting time point to another time point before a predetermined time elapses. The operation starting time point of the power conversion apparatus 10 may be a time point at which the power conversion apparatus 10 is actuated or a time point at which the operation of the power conversion apparatus 10 is actually started after the power conversion apparatus 10 is actuated.

Subsequently, the controller 21 calculates a value of temperature increase based on the temperature T0 of each thermistor observed when the operation of the apparatus is started and the temperature Tx of each thermistor observed after t1 seconds have elapsed since the initiation of apparatus operation (i.e., after a certain time has elapsed), and determines whether or not the value of temperature increase measured by each thermistor of the resonance circuit is equal to or greater than a set value (Tx−T0≥C) (step S34).

If it is determined in step S34 that the value of temperature increase measured by each thermistor is equal to or greater than a set value C (Tx−T0≥C) (step S34; Yes), the controller 21 determines that the thermistor in the area where the value of temperature increase is equal to or greater than a set value is operating normally, continues the temperature measurement, uses the measurement result in the processes of detecting the abnormality of the resonance frequency shown in FIGS. 4 to 6, and ends the process of detecting the abnormality of the thermistors (step S35).

On the other hand, if it is determined in step S34 that the value of temperature increase measured by each thermistor is less than a set value C (Tx−T0<C) (step S34; No), the controller 21 determines that the thermistor in the area where the value of temperature increase is less than a set value C is broken due to an absence of a temperature increase or an insufficient value of a temperature increase measured by the thermistor, cuts off the output from the broken thermistor from the process of detecting the abnormality of the resonance frequency (i.e., does not use a measurement value provided by the broken thermistor in the process of detecting the abnormality of the resonance frequency), uses only the normal thermistors to detect temperature in the processes of detecting the abnormality of the resonance frequency shown in FIGS. 4 to 6, and ends the process of detecting the abnormality of the thermistors (step S36).

To adopt a conventional method, for example, it is necessary to install a current detector. However, a current detector is difficult to deploy in an apparatus to be used in a severe temperature environment since it generates a large amount of heat by itself when used for high frequency.

Also, since a current detector for high frequency has a large outer shape, it poses the further problem of not fitting the space in the apparatus and leading to increased cost.

Furthermore, even if these problems are overcome, a further problem arises whereby the costs increase due to the additional need of a high-speed microcomputer or FPGA as a detection circuit.

Accordingly, with the focus placed on an increase in the loss caused by a change in the resonance frequency, a possible approach would be to install thermistors in multiple areas to detect an increase in the resonance frequency based on the measured temperatures and thereby detect an abnormality of the resonance frequency.

However, since multiple thermistors are installed to monitor the temperatures of multiple areas with individual set values, if a temperature detected by a thermistor exceeds a given value, the protection function of the apparatus operates by detecting it as a temperature abnormality, therefore stopping the entire apparatus. Thus, in response to that one of the thermistors breaks down and erroneously detects an excess temperature, the entire apparatus stops.

In contrast, as described above, according to the first embodiment, it is possible to detect an abnormality of each thermistor used to detect an abnormality of the resonance frequency based on a value of temperature increase of each thermistor from the temperature observed when the apparatus operation is started, and possible to prevent erroneous detection of an excess temperature due to the abnormality of the thermistor and thereby prevent the power conversion apparatus from being excessively stopped.

That is, according to the power conversion apparatus 10 of the first embodiment, it is possible to continue monitoring the temperatures of the resonance capacitors and improve the redundancy of the apparatus by preventing the entire apparatus from being excessively stopped even if one of the thermistors in the resonance circuit is broken.

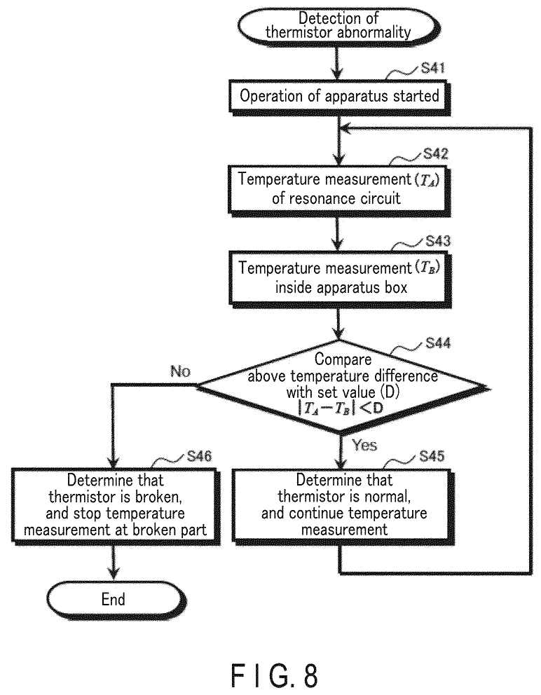

FIG. 8 is a process flowchart explaining a method of detecting an abnormality of a thermistor according to a second embodiment. After the operation of the apparatus is started, the temperature detector 23 measures a temperature TA of each of the resonance capacitors 12U and 12L or a temperature TA of each of the conductors connected to the resonance capacitors 12U and 12L (step S42). For temperature comparison, a measurement value provided by a thermistor that measures a different temperature (a temperature of an area different from the area in the resonance circuit) is used. In this embodiment, a temperature measurement value TB of a thermistor that measures a temperature inside the apparatus box is used (step S43).

Subsequently, the controller 21 calculates a temperature difference between the temperature measurement value TA of each thermistor of the resonance circuit and the measurement value TB of the temperature inside the apparatus box for each cycle, and determines whether or not the temperature difference is less than a temperature set value D (|TA−TB|<D) (step S44).

If it is determined in step S44 that a temperature difference between the temperature measurement value TA of each thermistor of the resonance circuit and the measurement value TB of the temperature inside the apparatus box is less than a temperature set value D (|TA−TB|<D) (step S44; Yes), the controller 21 determines that the thermistor in the area where the temperature difference is less than a temperature set value D is operating normally and continues the temperature measurement (step S45).

If it is determined in step S44 that a temperature difference between the temperature measurement value TA of each thermistor of the resonance circuit and the measurement value TB of the temperature inside the apparatus box is equal to or greater than a temperature set value D (|TA−TB|≥D) (step S44; No), the controller 21 determines that the thermistor in the area where the temperature difference is equal to or greater than a temperature set value D is broken due to the abnormality of the temperature output by the thermistor with respect to the measurement value of the temperature inside the apparatus box, and cuts off the output from the broken thermistor from the process of detecting the abnormality of the resonance frequency (i.e., does not use a measurement value provided by the broken thermistor in the process of detecting the abnormality of the resonance frequency) (step S46).

The second embodiment differs from the first embodiment in that a temperature measurement value of the resonance circuit is compared with a temperature measurement value in a different temperature measurement area; however, according to the second embodiment, as in the first embodiment, it is possible to detect an abnormality of each thermistor used to detect an abnormality of the resonance frequency and prevent erroneous detection of an excess temperature due to the abnormality of the thermistor thereby preventing the power conversion apparatus from being excessively stopped. It is also possible to detect an abnormality of each thermistor at all times while the apparatus is being operated by making a comparison with a different temperature measurement area, as in the second embodiment.

That is, according to the power conversion apparatus 10 of the second embodiment, it is possible to continue monitoring the temperatures of the resonance capacitors and improve the redundancy of the apparatus by preventing the entire apparatus from being excessively stopped even if one of the thermistors in the resonance circuit is broken.

In this embodiment, a temperature inside the apparatus box is used as a temperature of another temperature measurement area; however, temperatures of any areas including temperatures of different temperature measurement areas inside the apparatus such as a converter unit, an inverter unit, etc., may be used, provided that a comparison with the temperature of the resonance circuit can be made.

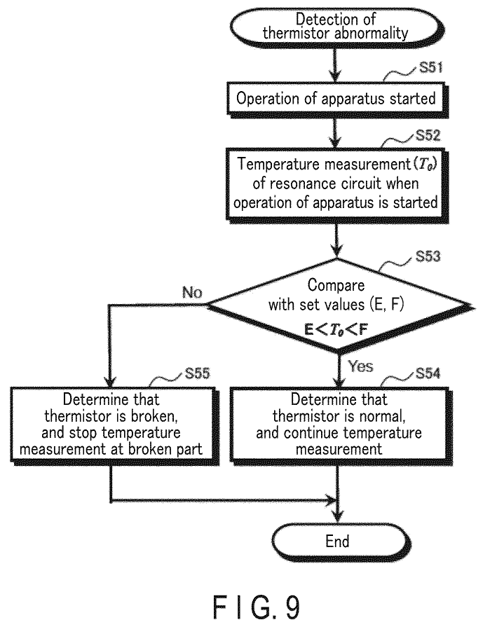

FIG. 9 is a process flowchart explaining a method of detecting an abnormality of a thermistor according to a third embodiment.

The third embodiment differs from the first embodiment in that an abnormality of a thermistor is determined based on a temperature initially measured by the thermistor when the operation of the apparatus is started.

The temperature detector 23 measures an initial temperature T0 detected by each thermistor when the operation of the power conversion apparatus 10 is started (step s52).

Subsequently, the controller 21 determines whether or not the initial temperature T0 of each thermistor is higher than a lower limit set value E and lower than an upper limit set value F (E<T0<F) (step S53). The set value E is set to an obviously small value, and the set value F is set to an obviously large value. These values are set to, for example, a range of temperature that allows for the use of a thermistor to be used, a value that takes into account a range of temperature in which the apparatus is used, or the like.

If it is determined in step S53 that the initial temperature T0 of each thermistor is higher than the lower limit set value E and lower than the upper limit set value F (E<T0<F), the controller 21 determines that the thermistor is operating normally and continues the temperature measurement (step S54).

If it is determined in step S53 that the initial temperature T0 of each thermistor is equal to or lower than the lower limit set value E and equal to or higher than the upper limit set value F (T0≤E, F≤T0), the controller 21 determines that the thermistor in the area where the initial temperature T0 is equal to or lower than the lower limit set value E and equal to or higher than the upper limit set value F is broken due to the output of an obviously abnormal temperature from the thermistor, and cuts off the output from the broken thermistor from the process of detecting the abnormality of the resonance frequency (i.e., does not use a measurement value provided by the broken thermistor in the process of detecting the abnormality of the resonance frequency) (step S55).

According to the third embodiment, an abnormality of a thermistor can be easily detected by determining that a thermistor is broken in response to that an initial temperature measured by the thermistor has an obviously abnormal value.

As in the first embodiment, according to the power conversion apparatus 10 of the third embodiment, it is possible to continue monitoring the temperature of the resonance capacitor and improve the redundancy of the apparatus by preventing the entire apparatus from being excessively stopped even if one of the thermistors in the resonance circuit is broken.

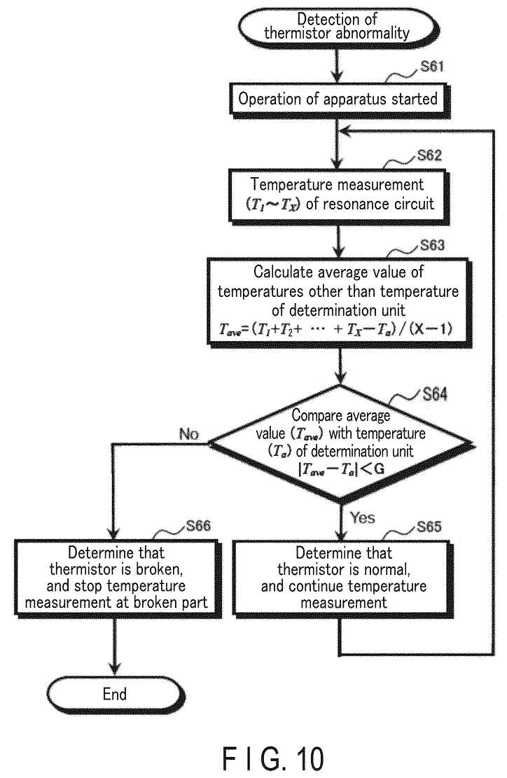

FIG. 10 is a process flowchart explaining a method of detecting an abnormality of a thermistor according to a fourth embodiment.

The fourth embodiment differs from the second embodiment in that a temperature comparison for the determination of the breakdown of a thermistor is performed using an average value of temperature measurement values of thermistors other than the thermistors of the resonance circuit that are to be determined as broken or not.

The temperature detector 23 detects temperatures (T1 to Tx) measured by x (x≥2) thermistors installed in multiple areas, and the controller 21 calculates an average value Tave of the temperatures other than temperatures Ta (a=1, 2, . . . , x) of the thermistors that are to be determined as broken or not (step S63).

Subsequently, the controller 21 calculates a difference between the average value Tave and the temperatures Ta of the thermistors that are to be determined as broken or not, and determines whether or not the difference is less than a set value G (|Tave−Ta|<G) (step S64).

If it is determined in step S64 that a difference between the average value Tave and the temperatures Ta of the thermistors that are to be determined as broken or not is less than a set value G (|Tave−Ta|<G), the controller 21 determines that the thermistor in the area where the difference is less than a set value G is operating normally and continues the temperature measurement (step S65).

If it is determined in step S64 that a difference between the average value Tave and the temperatures Ta of the thermistors that are to be determined as broken or not is equal to or greater than a set value G (|Tave−Ta|≥G), the controller 21 determines that the thermistor in the area where the difference is equal to or greater than a set value G is broken and cuts off the output from the broken thermistor from the process of detecting the abnormality of the resonance frequency (i.e., does not use a measurement value provided by the broken thermistor in the process of detecting the abnormality of the resonance frequency) (step S66).

A determination of the breakdown of the other thermistors is likewise performed by comparing the temperatures of the thermistors with an average value of the temperatures of all the thermistors excluding said aforementioned thermistors.

According to the fourth embodiment, in response to that two or more thermistors are installed, a temperature of one of the thermistors of the resonance circuit that perform temperature measurement is compared with an average value of the temperatures of all the thermistors of the resonance circuit excluding the aforementioned thermistors, whereby an abnormality of each thermistor used to detect an abnormality of the resonance frequency can be detected.

That is, according to the power conversion apparatus 10 of the forth embodiment, it is possible to continue monitoring the temperature of the resonance capacitor and improve the redundancy of the apparatus by preventing the entire apparatus from being excessively stopped even if one of the thermistors in the resonance circuit is broken.

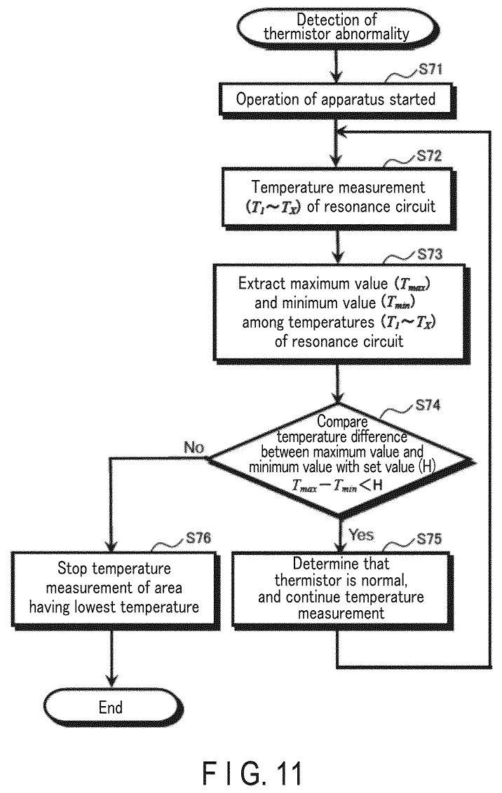

FIG. 11 is a process flowchart explaining a method of detecting an abnormality of a thermistor according to a fifth embodiment. The fifth embodiment differs from the other embodiments in that a determination of the breakdown of the thermistors is made only for the thermistors in a highest-temperature area and a lowest-temperature area, whereas in the other embodiments a determination of the breakdown of the thermistors is made for each of the multiple thermistors of the resonance circuit. That is, in the fifth embodiment, the controller 21 determines whether the thermistors are broken or not by using the highest temperature and the lowest temperature among the measurement values of the thermistors.

The controller 21 extracts the highest temperature Tmax and the lowest temperature Tmin among the temperatures (T1 to Tx) of x thermistors of the resonance circuit measured by the temperature detector 23 (step S73), and determines whether or not a difference between the highest temperature Tmax and the lowest temperature Tmin is less than a set value H (Tmax−Tmin<H) (step S74).

If it is determined in step S74 that a difference between the highest temperature Tmax and the lowest temperature Tmin is less than a set value H (Tmax−Tmin<H), the controller 21 determines that all the thermistors are operating normally and continues the temperature measurement (step S75).

If it is determined in step S74 that a difference between the highest temperature Tmax and the lowest temperature Tmin is equal to or greater than a set value H (Tmax−Tmin≥H), the controller 21 determines that the thermistor that has measured the lowest temperature is broken, cuts off the output from the thermistor that has measured the lowest temperature from the process of detecting the abnormality of the resonance frequency (i.e., does not use a measurement value provided by the broken thermistor in the process of detecting the abnormality of the resonance frequency), uses only the remaining thermistors to detect an abnormality of the resonance frequency, and ends the process of detecting the abnormality of the thermistors. The breakdown of the thermistors that causes an increase in a resistance value increases the likelihood that a detected temperature will be low. Thus, in this embodiment, the controller 21 determines that the thermistor that has measured the lowest temperature Tmin is broken.

According to the fifth embodiment, an abnormality of a thermistor can be easily detected by observing the highest temperature and the lowest temperature of the temperature measurement areas of the resonance circuit.

That is, according to the power conversion apparatus 10 of the fifth embodiment, it is possible to continue monitoring the temperature of the resonance capacitor and improve the redundancy of the apparatus by preventing the entire apparatus from being excessively stopped even if one of the thermistors in the resonance circuit is broken.

For example, there may be provided a program for controlling, via use of a computer, a power conversion apparatus that includes: a chopper that converts power from a power supply into direct-current power and outputs the direct-current power; an inverter that converts the direct-current power output by the chopper into alternate-current power; resonance capacitors forming a resonance circuit and connected in two series to a direct-current input section of the inverter; and a high-frequency transformer that converts the alternate-current power of the inverter, wherein the program causes the computer to implement a means of detecting a temperature of the resonance circuit, a means of detecting an abnormality of a resonance frequency in response to that the temperature is equal to or higher than a predetermined temperature threshold and executing control for handling the abnormality, and a means of detecting an abnormality of thermistors of the resonance circuit and executing control for handling the abnormality.

Also, an abnormality of the thermistors may be detected based on a logical sum or a logical product that uses the multiple determinations of breakdown made in the first to fifth embodiments.

In the descriptions provided above, the temperature detector 23 is arranged near the resonance capacitors; however, the arrangement of the temperature detector 23 is not limited thereto. The temperature detector 23 may be arranged in various areas of the resonance circuit RES such as near a high-frequency transformer, provided that a temperature change according to the abnormality of the resonance frequency can be detected in these areas. Detection of an abnormality of the thermistors can likewise be performed.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

The program according to the present embodiment may be transferred in a state of being stored in an electronic device or in a state of not being stored in an electronic device. In the latter case, the program may be transferred through a network or may be transferred in a state of being stored in a storage medium. The storage medium is a non-transitory tangible medium. The storage medium is a computer-readable medium. The storage medium may be of any type, such as a CD-ROM or a memory card, as long as it can store programs and can be read by a computer.

What is claimed is:

1. A power conversion apparatus comprising:
a voltage adjusting circuit configured to adjust power from a power supply to power of a desired voltage;
an inverter configured to convert the power output by the voltage adjusting circuit into alternate-current power;
a resonance circuit having an inductance and a capacitance;
a high-frequency transformer configured to convert a voltage of the alternate-current power of the inverter;
a rectifier configured to convert the alternate-current power output from the high-frequency transformer into direct-current power;
temperature detector configured to detect respective temperatures of two or more areas of the resonance circuit; and
a controller configured to: detect an abnormality of a resonance frequency in response to that at least one of the temperatures are equal to or higher than a predetermined temperature threshold, and execute control for handling the abnormality; and also detect an abnormality of the temperature detector configured to detect the temperatures of the resonance circuit, and, in response to detected an abnormality of the temperature detector, execute control to cut off an abnormal output from the temperature detector from the detection of an abnormality of the resonance frequency.

2. The power conversion apparatus according to claim 1, wherein the controller calculates a value of an increase of the temperatures detected by the temperature detector after a certain period of time has elapsed since an operation of the apparatus is started, and determines an abnormality of the temperature detector based on the temperature increase value.

3. The power conversion apparatus according to claim 1, wherein the controller determines an abnormality of the temperature detector by comparing the temperatures of the resonance circuit detected by the temperature detector with a temperature measured by a temperature measuring unit configured to measure a temperature of an area different from the resonance circuit.

4. The power conversion apparatus according to claim 1, wherein the controller measures an initial temperature of the resonance circuit when an operation of the temperature detector is started, and determines an abnormality of the temperature detector based on the initial temperature.

5. The power conversion apparatus according to claim 1, wherein the controller determines an abnormality of the temperature detector by comparing a temperature measured by the temperature detector with an average value of temperatures measured by the other temperature detector.

6. The power conversion apparatus according to claim 1, wherein the controller determines an abnormality of the temperature detector by comparing a maximum temperature and a minimum temperature among the temperatures detected by the temperature detector.

7. The power conversion apparatus according to claim 1, wherein the temperature detector includes at least one of thermistors.
